(19) United States
(12) Patent Application Publication
(10) Pub. No.: US 2005/0048304 A1
(43) Pub. Date: Mar. 3, 2005

(54) Decoratively finished thermoplastic product and method for manufacturing same

(76) Inventor: Ronald D. Jones, Tulsa, OK (US)

Correspondence Address: BRENT A. CAPEHART;LaRiviere, Grubman & Payne, LLP, 19 Upper Ragsdale Drive, Suite 200, P.O Box 3140, Monterey, CA, 74159, US

(21) Appl. No.: 10/649,190

(22) Filed: Aug. 27, 2003

(51) Int. Cl. B32B 9/04

(52) U.S. Cl. 428/542.2; 428/543

(57) ABSTRACT

The invention relates to a decoratively finished product comprising a substrate made of polyphenylsulfone (PPSF), polycarbonate (PC), or ABS thermoplastic fabricated on a fused deposition modeling (FDM) machine or made of photo-curable resin or photo-curable resins blended with filling materials such as ceramic powder, nano-clay particles or nano-carbon tubes fabricated on a SterioLithography Apparatus (SLA) or made of powdered aluminum, glass-filled nylon or other powdered polymers fabricated on a Selective Laser Sintering (SLS) machine having a solid shape or hollow shape including internal cavities, channels or internal reinforcing structures to which either a metal surface is electroplated or applied by a plastic electroplating vapor deposition method or a finish simulating a range of natural and synthetic materials is applied using a water transfer printing method. The decoratively finished thermoplastic product includes various favorable characteristics, such as, being lightweight, exceptionally strong, scratch-resistant, and in the case of PPSF, flame retardant, resistance to many chemicals, capable of integrating imbedded components and possessing high thermal characteristics.

This application is not based upon any pending domestic or international patent applications.

### REFERENCE TO MICROFICHE APPENDIX

This application is not referenced in any microfiche appendix.

### FIELD OF INVENTION

The invention relates to a decoratively finished product comprising a substrate made of polyphenylsulfone (PPSF), polycarbonate (PC), ABS or other thermoplastic fabricated on a fused deposition modeling (FDM) machine or made of photo-curable resin or photo-curable resins blended with filling materials such as ceramic powder, nano-clay particles or nano-carbon tubes fabricated on a SterioLithography Apparatus (SLA) or made of powdered aluminum, glass-filled nylon or other powdered polymers fabricated on a Selective Laser Sintering (SLS) machine having a solid shape or hollow shape including internal cavities, channels or internal reinforcing structures to which either a metal surface is electroplated or applied by a plastic electroplating vapor deposition method or a finish simulating a range of natural and synthetic materials is applied using a water transfer printing method. The decoratively finished thermoplastic product includes various favorable characteristics, such as, being lightweight, exceptionally strong, scratch-resistant, flame retardant, resistance to many chemicals, capable of integrating imbedded components and possessing high thermal characteristics.

### BACKGROUND OF THE INVENTION

The business of applying a decorative finish to a substrate material has been practiced for many years in different forms. Metal plating over a lesser quality material has been practiced in many forms including the application of veneers, gold leaf, metal paints and electroplating. Applying various coatings over a lesser material has been practiced for many years as well in different forms and in different materials to simulate highly valued materials such as exotic woods, carbon fiber, masonry of different types and burnished metals to name only a few. These practices have seen increased usage in recent years to create interior components and furnishings used in high value products like aircraft, yachts, automobiles and motor homes. Due to weight limitations and for reasons related to regulatory compliance, products used to construct or furnish aircraft interiors are increasingly fabricated from decoratively finished thermoplastics, lightweight metals and polymer matrix fiber reinforced composites. For example, a lavatory sink that appears to be made from a rare Italian marble material can be in fact constructed from a milled light aluminum alloy or molded thermoplastic finished with a veneer or surface treatment that closely resembles the appearance of the intended natural stone material.

Additionally, the cost of manufacture is a driving force in aircraft interiors as well as in the manufacture of many other high value vehicles and products. Typically, the higher the value of the vehicle or product, the lower the number of units sold in a given time. The cost of tooling to produce vehicle interior components therefore is a major concern to manufacturers of high end products where the production run is relatively short and thus the component cost for tooling on a cost per unit basis is high. Moreover, buyers of extremely high value vehicles such as business aircraft and yachts and motor coaches insist upon a high level of customization, especially in interior comforts and features. In an effort to accommodate the customer in what is are highly competitive industries, interior designers, completion centers and refurbishers are often faced with the prospect of either loosing the business or sacrificing profit. Thus, there is a need to create a substrate material having a decorative finish that is both efficient and economical and in the case of air vehicles lightweight.

### BRIEF SUMMARY OF THE INVENTION

The present invention satisfies the needs discussed above. The described invention employs a manufacturing method that relies upon computer files and any one of several automated layer fabrication techniques to create designer parts, products and components in high quality thermoplastics, sintered metals and polymers, and photo-curable thermosetting polymers finished as above described that are regulatory compliant for use in aircraft interiors that are also lightweight, are of sufficient quality to be accepted for use in other high end air and ground vehicles or marine vessels and because they are not produced using part specific tooling are economical and relatively quick to manufacture despite their high degree of customization.

### BRIEF DESCRIPTION OF THE DRAWINGS

FIG. 1 is a schematic of an embodiment of the fused deposition modeling process (FDM) aspect of the present invention.

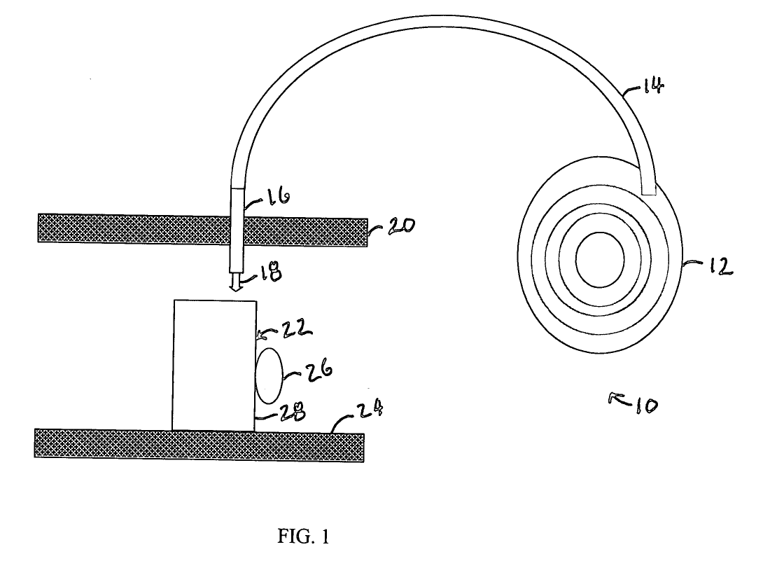

FIG. 2 is a schematic of an embodiment of the thermoplastic electroplating process aspect of the present invention.

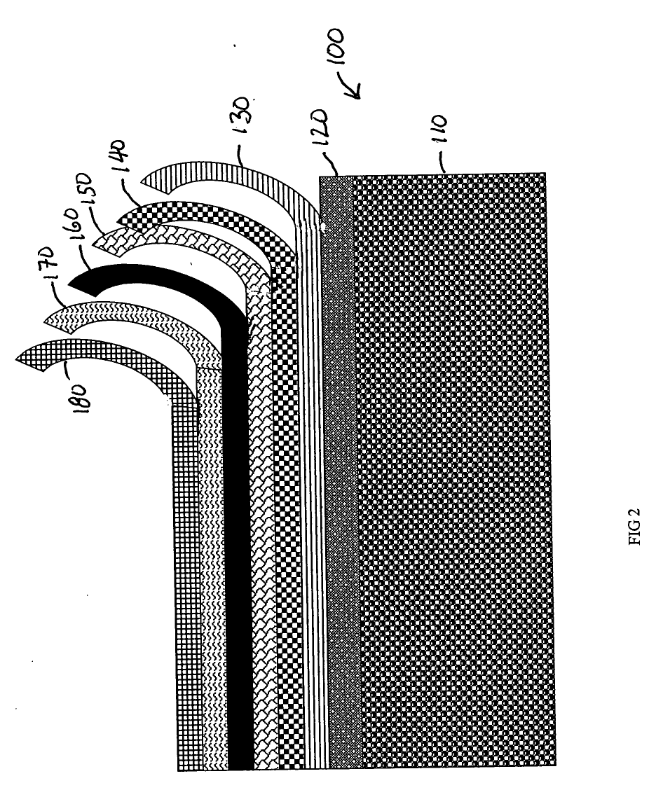

FIG. 3 is a schematic of an embodiment of the water transfer printing process aspect of the present invention.

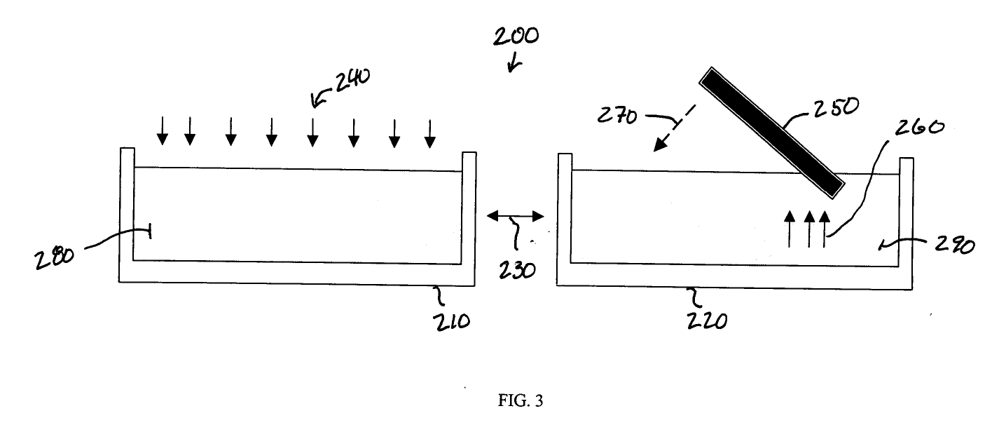

### DETAILED DESCRIPTION OF THE PREFERRED EMBODIMENTS

Before explaining the present invention in detail, it is to be understood that the invention is not limited to the preferred embodiments contained herein. The invention is capable of other embodiments and of being practiced or carried out in a variety of ways. It is to be understood that the phraseology and terminology employed herein are for the purpose of description and not of limitation.

An embodiment of the present invention for a decoratively finished thermoplastic product comprises a substrate made of polyphenylsulfone (PPSF), polycarbonate (PC), ABS or other thermoplastic fabricated on a fused deposition modeling (FDM) machine. The thermoplastic product is fabricated having a solid shape or hollow shape. It can also include internal cavities, channels or internal reinforcing structures. The thermoplastic product is then subjected to a process that alters its surface to simulating a range of natural and synthetic materials. These processes can include electroplating or vapor depositing a metal surface or applying a finish using a water transfer printing method. It is understood by those skilled in the art that the use of polyphenylsulfone (PPSF), polycarbonate (PC), or ABS thermoplastic is illustrative and is not limiting. Further, it is understood by those skilled in the art that the use of a fused deposition modeling (FDM) machine is also illustrative and is not meant to be limiting.

An embodiment of the present invention for a method for decoratively finished thermoplastic product comprises creating a thermoplastic product then altering its surface to simulating a range of natural and synthetic materials.

A further embodiment of the method for decoratively finished thermoplastic product comprises creating a thermoplastic product from polyphenylsulfone (PPSF), polycarbonate (PC), ABS or other thermoplastic.

Another embodiment of the method for decoratively finished thermoplastic product comprises creating the thermoplastic product by a fused deposition modeling process.

An embodiment of the fused deposition modeling process (FDM) comprises defining the thermoplastic part with a three-dimensional (3D) solid modeling computer-aided-design software computer program; editing the solid computer rendered model to match capabilities of FDM system, preparing the solid computer rendered model file for integration with the FDM, setting building parameters in the FDM software, unwinding a thermoplastic filament material from a supply coil specially manufactured for this purpose while simultaneously unwinding as needed a disposable or soluable build support material also from a supply coil specially manufactured for this purpose, supplying the thermoplastic filament material and the build support material as needed each to a designated extrusion nozzle that can be heated to a temperature sufficient to melt the thermoplastic filament or build support material, has a mechanism that allows the flow of the melted thermoplastic or build support material to be turned on and off, and is mounted to a mechanical stage that can be moved in both horizontal and vertical directions, moving either nozzle over the table portion of the FDM system in the required geometry as set forth by the building parameters and depositing extruded thermoplastic filament or build support material as needed to form each layer of one or more thermoplastic parts, repeating the above steps until the part or multiple parts are formed as 3 dimensional solid objects, and finishing the thermoplastic part cosmetic, structural and/or functional purposes

In the event support structures are fabricated by extruding build support material through its designated nozzle, they are later removed by either by physically breaking them away from the object or submerging the object within a water or other liquid solution thereby dissolving the support structures and thus affecting their removal from the object.

The layers of the thermoplastic filament material are capable of fusing to the lower layers due to their immediate hardening after being deposited and subjected to a temperature lower than the material's heat deflection or melting point. The entire system is contained within a chamber that is precisely held at a temperature just below the melting point of the various thermoplastic materials used in the FDM process.

A further embodiment of the method for decoratively finished thermoplastic product comprises altering its surface to simulating a range of natural and synthetic materials by a plastic electroplating vapor deposition process.

An embodiment of the plastic electroplating process comprises applying a layer of electroless copper autocatalytically to provide a conductive layer for subsequent electroplating processes, applying a layer of Semi-bright Copper Strike to add thickness, improve plating adhesion, and to protect against metal bum-off at the point of rack contact, applying a layer of bright acid copper to provide leveling and good thermal cycling, applying a layer of bright nickel to strengthen the thermoplastic part and provide for a highly reflective finish, applying a layer of satin steel to add a less-reflective satin appearance, applying a layer of chromium to protect the nickel layer against corrosion and to provide a clean final finish, applying a layer of thermoplastic vapor deposition (PVD) to provide a durable, scratch-resistant finish and applying multiple de-ionized water rinses and hot air dryers to prevent water spotting.

Another embodiment of the plastic electroplating process comprises applying layers of the plastic vapor deposition (PVD) onto nickel, satin, and/or bright chrome finish.

A further embodiment of the method for decoratively finished thermoplastic product comprises altering its surface to simulating a range of natural and synthetic materials by a water transfer printing process.

An embodiment of the water transfer printing process comprises spray painting one ore more FDM fabricated thermoplastic parts to apply an appropriately colored sub-coat and allowing it to dry, floating a soluble film material with a desired ink pattern contained therein on top of a quantity of water located in a specially designed dipping tank, spraying the soluble film containing the desired ink pattern with an activator that dissolves the film thus enabling the ink pattern to float intact on the water surface, dipping one or more thermoplastic parts into the tank wherein the inks pattern transfers onto the one or more thermoplastic parts, and then applying a layer of a clear coat finish to the one or more thermoplastic parts.

Examples of various applications of this embodiment of the present invention include water facets, lavatory and galley sinks and trim, cabinetry and cabinet faces, drawers and drawer liners, galley ice chests and sanitary water containers, moldings and furniture trim, frames and enclosures, toilet seats, handles, window shades, window trim and valences, lighting and control switch plates, vanity, galley and table tops, and electronic component housings.

While the invention has been described with a certain degree of particularity, it is manifest that many changes may be made in the details of construction and the arrangement of components without departing from the spirit and scope of this disclosure. It is understood that the invention is not limited to the embodiments set forth herein for purposes of exemplification, but is to be limited only by the scope of the attached claims, including the full range of equivalency to which each element thereof is entitled.

1. A decoratively finished thermoplastic product comprising:
a substrate made of thermoplastic having a surface fabricated to simulate natural or synthetic materials.
